(19) United States
(12) Patent Application Publication
(10) Pub. No.: US 2011/0296652 A1
(43) Pub. Date: Dec. 8, 2011

(54) THREE-DIRECTION ADJUSTABLE HINGE

(75) Inventor: Gongchun ZHANG, Zengcheng City (CN)

(73) Assignee: BETTELI INC HONG KONG, MID-LEVELS (HK)

(21) Appl. No.: 12/795,787

(22) Filed: Jun. 8, 2010

(51) Int. Cl. E05D 7/06; E05D 11/10

(52) U.S. Cl. 16/239

(57) ABSTRACT

An adjustable hinge assembly is provided with three dimensional adjustment along X, Y and Z axes. The hinge assembly includes a first leaf mounted to a door or window frame and a second leaf mounted to the door or window. The first and second leaves are pivotally coupled via aligned knuckles for adjustment along the Z axis. The second leaf includes a plate slidably received in a housing. The plate is adjustable along X and Y axes relative to the housing. Adjustments on the X, Y and Z axes can be quickly and easily made using an Allen wrench.

### BACKGROUND OF THE INVENTION

Hinges for doors and windows are well known, and typically include a first leaf screwed or otherwise mounted to the door or window frame and a second leaf screwed or mounted to the movable door or window. Adjustable hinges are also known which allow adjustment of the hinge leaves in one or two directions to improve the ability to align the door or window within the frame. For example, U.S. Pat. No. 5,701,636 describes an adjustable hinge having two degrees of adjustability about the Y and Z axes. However, the hinge of this patent does not accommodate adjustability in a third degree along the X axis, which is sometimes desirable or necessary.

Therefore, a primary objective of the present invention is the provision of an improved adjustable hinge having three degrees or axes of adjustability.

Another objective of the present invention is the provision of an improved hinge having adjustability in the X, Y and Z axes.

A further objective of the present invention is the provision of an adjustable hinge having a separate component installed on a door or window frame and on the door or window, and then assembling the components together.

Still another objective of the present invention is the provision of an adjustable hinge which allows the relative positions of a door or window with a surrounding frame to be adjusted after the hinge leaves are mounted on the door or window and on the frame.

Yet another objective of the present invention is the provision of an adjustable hinge which is quick and easy to adjust without removing the hinge leaves from the door or window and the frame.

Another objective of the present invention is the provision of an improved adjustable hinge which is quick and easy to install.

These and other objectives will become apparent from the following description of the invention.

### BRIEF SUMMARY OF THE INVENTION

The improved hinge of the present invention has three degrees of adjustability, in X, Y and Z axes. More particularly, the adjustable hinge includes a first leaf and a second leaf pivotally coupled to the first leaf, with the leaves being adjustable about three axes. The second leaf includes a plate slidably received within a housing, with the plate being adjustable about the X and Y axes relative to the housing. The two leaves are also adjustable along a Z axis relative to one another. The Z axis extends along the hinge axis between the leaves. The selected adjusted positions of the leaves are maintained by threaded members. The leaves are adjustable about the X, Y and Z axes after the leaves are mounted on a door or window and surrounding frame. Covers are provided on the leaves to hide the mounting screws or hardware.

### BRIEF DESCRIPTION OF THE DRAWINGS

FIG. 1 is a front perspective view of the improved adjustable hinge assembly of the present invention.

FIG. 2 is a rear perspective view of the hinge assembly.

FIG. 3 is a partially exploded front perspective view of the hinge components.

FIG. 4 is a partially exploded rear perspective view of the hinge components.

FIG. 5 is an exploded perspective view of the hinge components.

FIG. 6 is an exploded view of the second leaf plate and Z axis adjustment components.

FIGS. 7 and 8 are sectional views showing two Y axis adjustment positions for the hinge of the present invention.

FIG. 9 is a perspective view showing an alternative embodiment of the X axis adjustment mechanism.

FIG. 10 is an exploded view of the components shown in FIG. 9.

### DETAILED DESCRIPTION OF THE DRAWINGS

The adjustable hinge of the present invention is generally designated in the drawings by the reference numeral 10. The hinge 10 includes first and second leaves 12, 14. Each leaf 12, 14 includes a plurality of holes 16 through which screws 18 extend for mounting the leaves 12, 14 to the door or window frame and to the door or window, respectively. The first leaf 12 includes upper and lower knuckles 20 and the second leaf includes a central knuckle 22. The knuckles 20, 22 are aligned to define the Z pivot axis of the hinge 10, as described below.

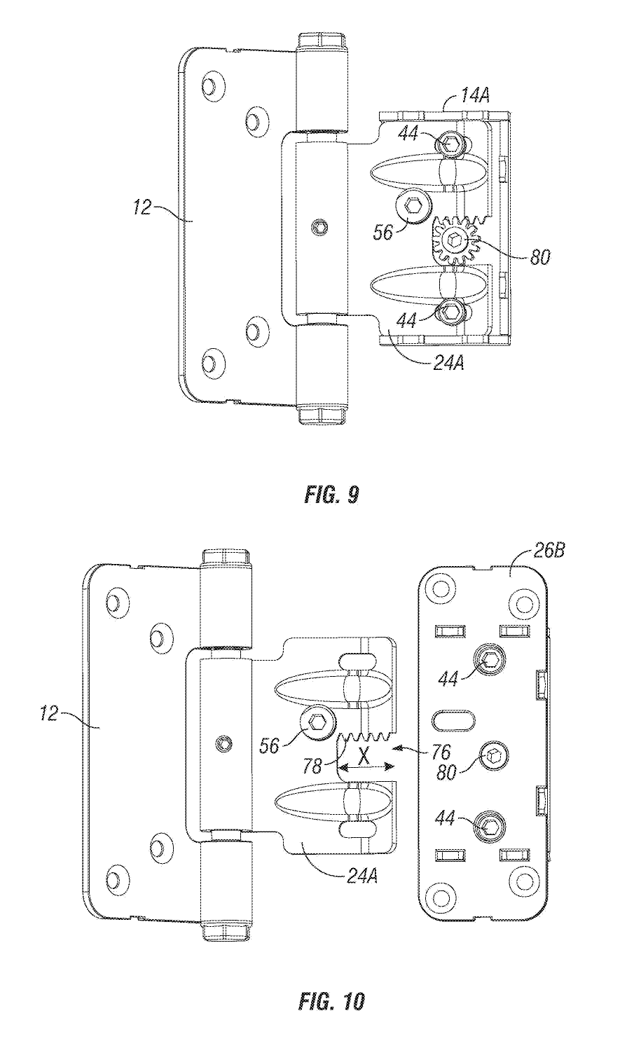

The second leaf 14 includes a plate 24 extending laterally from the knuckle 22 and slidably received within a housing or box 26 having an open side 28. The housing 26 preferably includes a back wall 30 with integral top and bottom edges 32, 34 and an integral outer edge 36. A front wall 38 mounts to tabs 40 on the edges 32, 34 and 36 and is secured thereto by swedging or other convenient means. In FIGS. 6 and 9, the front wall is removed for clarity. The inside edge opposite the outer edge 36 is open to form the opening 28 for receiving the plate 24 of the leaf 14, as best seen in FIGS. 2 and 4.

The plate 24 includes a pair of horizontal, elongated slots 42. A pair of press screws or threaded pins 44 extend through the slots 42 and are received in threaded holes 46 in the back wall 30 of the housing 26. Thus, when the press screws 44 are loosened, the plate 24 can move laterally along the X axis relative to the housing 26. A latch or controller 48 is pivotally mounted between the back wall and front wall 38 of the housing 26, and includes an ear 50 received within a notch 52 in the plate 24. The end of the latch 48 includes a hex opening to receive an Allen wrench for rotating the latch 48 about its axis, such that the ear 50 slides the plate 28 in opposite horizontal directions along the X axis for precision adjustment of the plate 24 relative to the housing 26. When the plate 24 is in the desired position, the press screws 44 are tightened to lock the plate 24 in the selected position within the housing 26. The ends of the press screws 44 also have a hex opening for receiving the Allen wrench for tightening and loosening the screws 46.

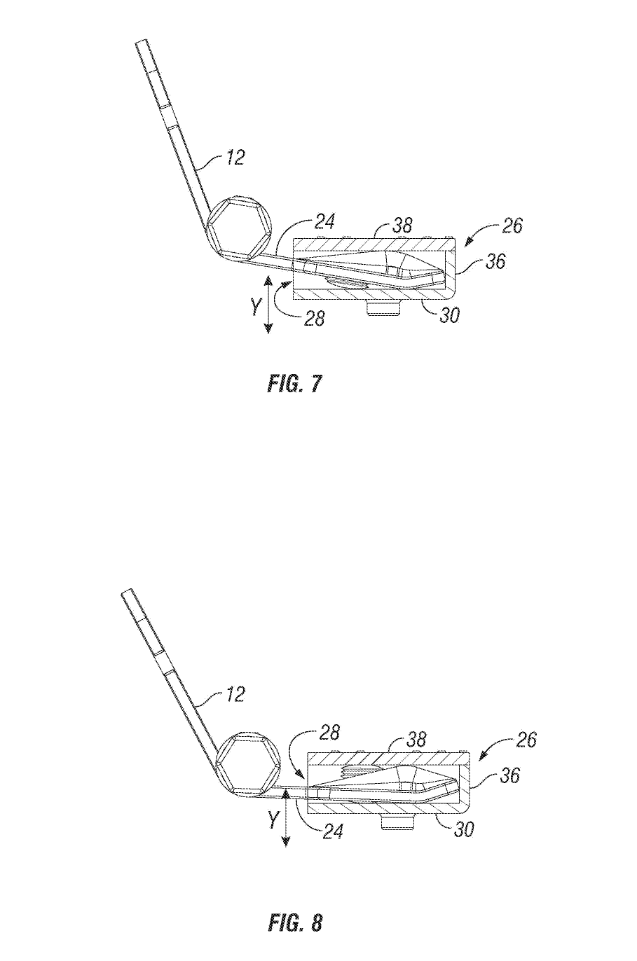

The plate 24 of the second leaf 14 also has a threaded hole 54 for threadably receiving an adjustment screw 56. The adjustment screw 56 has a hex opening in the front end to receive an Allen wrench extending through and aligned hole 58 in the front wall 38 of the housing 26. As seen in FIGS. 7 and 8, the screw 56 can be adjusted to extend a desired distance through the plate 24 so as to engage the back wall 30 of the housing 26, thereby pivoting the plate 24 about a Y axis. For example, when the screw 56 is fully extended through the plate 24, the plate is pivoted a maximum distance forwardly, as seen in FIG. 7. Similarly, when the screw 56 is retracted, the plate 24 is pivoted a maximum distant rearwardly along the Y axis, as seen in FIG. 8.

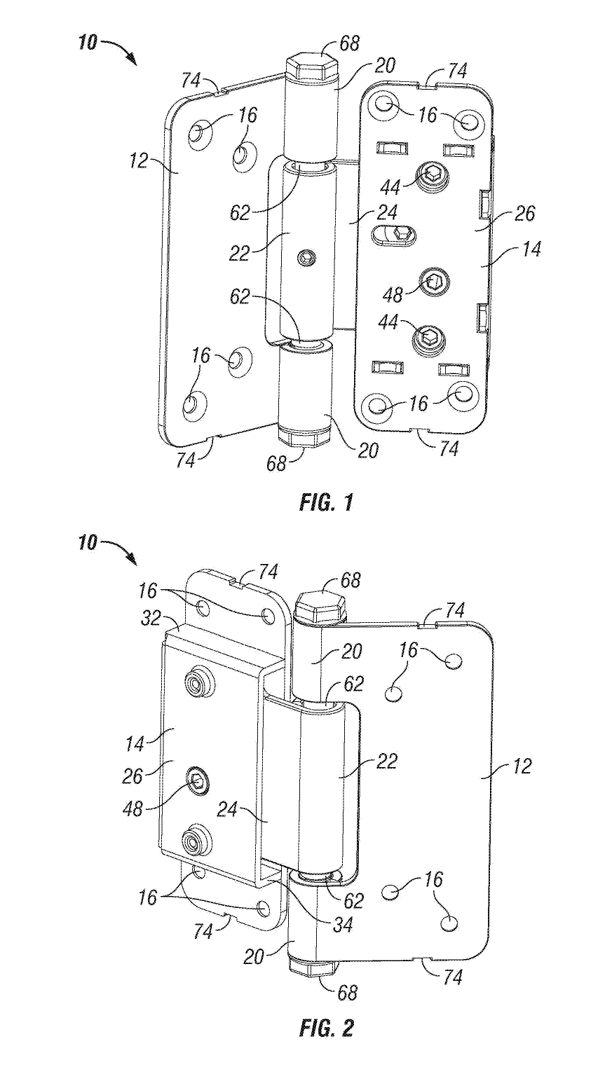

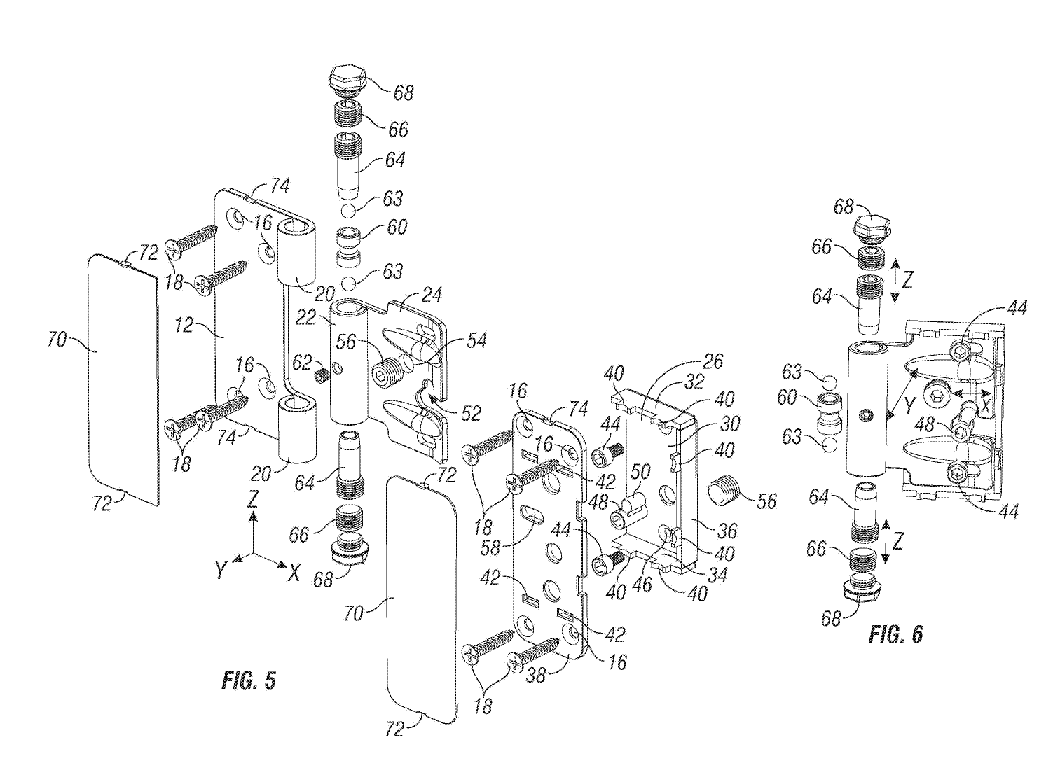

FIGS. 5 and 6 show the mechanism for adjusting the hinge leaves 12, 14 along their hinge Z axis. More particularly, a stop bar or member 60 is fixed in the center of the knuckle 22 by a set or lock screw 62 using an Allen wrench. A ball or bead 63, preferably made of steel, resides on the upper and lower ends of the stop member 60. Upper and lower adjustment screws 64 extend through the respective knuckles 20 of the first leaf 12 and into the knuckle 22. The inside of the knuckles 20 are threaded to matingly receive the threaded ends of the adjustment screws 64, which have a hex opening on their outer ends for receiving an Allen wrench so as to fix the position of the screws 64 within the knuckles 20. As seen in FIG. 1, the space between the knuckles 20 is greater than the length of the knuckle 22, thereby allowing the knuckle 22 to be adjusted along the Z axis, depending upon the threaded position of the adjustment screws 64 within the knuckles 20. Once the position of the knuckle 22 relative to the knuckles 20 is set, stop or lock screws 66 are threaded into the knuckles 20 to maintain the adjustment screws in their set position. Upper and lower nut caps 68 are then threaded into the knuckles 20 so as to close the upper and lower ends of the knuckles, as best seen in FIGS. 1 and 2.

If desired, cover plates 70 may be installed over the first leaf 12 and the second leaf 14. Preferably, each cover plate has a pair of tabs 72 which snap fit into notches or recesses 74 in the first leaf 12 and in the front wall 38 of the second leaf housing 26. The cover plates 70 hide the mounting screws 18.

From the foregoing it can be seen and understood that the leaves 12, 14 are adjustable along the X, Y and Z axes. The latch 48 and press screws 44 control horizontal adjustment along the X axis. The adjustment screw 56 controls front and back adjustment along the Y axis. The adjustment screws 64 control vertical adjustment along the Z axis. Preferably, the first leaf 12 is mounted upon the door or window frame, while the second leaf 14 is mounted on the door or window. The adjustments along the three axes can normally be quickly and easily made after the leaves 12, 14 are installed on the frame and on the door or window using the screws 18. After the leaves 12, 14 are properly set, the cover plates 70 can be snap fit into place to provide a clean, finished look to the hinge 10.

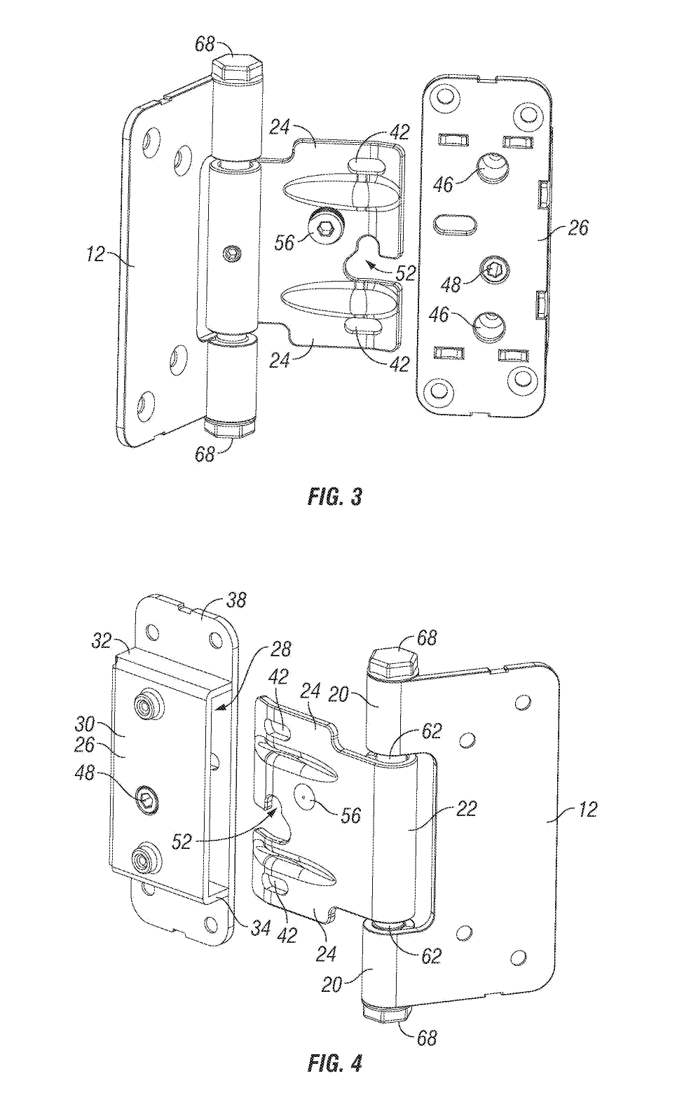

FIGS. 9 and 10 show an alternative embodiment of the second leaf 14A. More particularly, the plate 24A has a notch 76 with a plurality of teeth 78, rather than the notch 52 shown in the first embodiment (FIGS. 3-5). The housing 26B includes a gear 80, in place of the latch 48 of the first embodiment. The teeth of the gear 80 mesh with the teeth 78 of the notch 76. The end of the gear 80 includes a hex opening for receiving an Allen wrench so that gear 80 can be turned clockwise and counterclockwise, thereby adjusting the lateral position of the plate 24A along the X axis relative to the housing 26B.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A hinge pivotally mounting a door or window to a frame, comprising:
a first leaf with a first hollow knuckle;
a second leaf with a second hollow knuckle;
the knuckles being axially aligned so as to define a first adjustment axis;
a pin extending through the knuckles and adjustably coupling the knuckles together for variable spacing along the first axis;
the second leaf including a plate extending laterally from the second knuckle and a housing to slidably receive the plate along a second adjustment axis perpendicular to the first axis;
a lock member to lock the plate in a selected position relative to the housing; and
an adjustment member operative between the plate and the housing to adjust the relative position of the plate relative to the housing about a third adjustment axis perpendicular to both the first and second adjustment axes.

2. The hinge of claim 1 wherein the second knuckle includes separate upper and lower knuckle portions on opposite ends of the first knuckle, and the pin includes separate upper and lower portions adjustably extending through the upper and lower knuckle portions, respectively.

3. The hinge of claim 1 wherein the second knuckle and pin are threadably coupled.

4. The hinge of claim 1 wherein the coupler includes at least one threaded member extending through the plate and threadably coupled to the housing.

5. The hinge of claim 1 wherein the adjustment member extends threadably through the plate.

6. The hinge of claim 1 further comprising an adjustment latch pivotally mounted in the housing and engaging the plate so as to adjust the position of the plate relative to the housing.

7. The hinge of claim 1 wherein the lock member is movable between locked and unlocked positions.

8. The hinge of claim 1 wherein the plate includes a slot extending parallel to the second axis and through which the lock member extends.

9. The hinge of claim 1 wherein the pin, lock member and adjustment member are accessible after the leaves are secured to the door or window and to the frame so as to make adjustments along any of the three axes.

10. The hinge of claim 1 further comprising first and second covers on the first and second leaves, respectively.

11. A hinge assembly, comprising:
a first leaf;
a second leaf pivotally coupled to the first leaf; and
the leaves being adjustable about X, Y and Z axes.

12. The hinge assembly of claim 11 wherein the second leaf includes a plate slidably received in a housing, and the plate being adjustable about the X and Y axes relative to the housing.

13. The hinge assembly of claim 11 wherein the Z axis defines a hinge axis between the leaves.

14. The hinge assembly of claim 11 wherein each leaf includes a knuckle, with the knuckles being adjustably coupled along the Z axis.

15. The hinge assembly of claim 11 further comprising a first threaded member connecting the leaves for adjustment about the Z axis.

16. The hinge assembly of claim 11 further comprising a rotatable controller on the second leaf to adjust the second leaf along the X axis.

17. The hinge assembly of claim 11 further comprising a first threaded member on the second leaf to lock the second leaf in an adjusted position along the X axis.

18. The hinge assembly of claim 11 further comprising a second threaded member on the second leaf to adjust the second leaf along the Y axis.

19. The hinge assembly of claim 11 wherein the leaves are adjustable along the X, Y, and Z axes after the leaves are mounted on a door and on a door frame.

20. The hinge assembly of claim 11 further comprising covers on the leaves to hide mounting hardware.
